(19) United States
(12) Patent Application Publication
(10) Pub. No.: US 2012/0110801 A1
(43) Pub. Date: May 10, 2012

(54) STRAP TENSIONING DEVICE

(75) Inventors: Xavier JOUBERT, Ambert (FR); Thierry Joubert, Ambert (FR)

(73) Assignee: Joubert Productions, Ambert (FR)

(21) Appl. No.: 13/231,310

(22) Filed: Sep. 13, 2011

(30) Foreign Application Priority Data
Nov. 4, 2010 (FR) 10.59069

(51) Int. Cl. B60P 7/06

(52) U.S. Cl. 24/68 CD

(57) ABSTRACT

A strap tensioning device that includes a base having one of the ends of which accommodates a rotating drum that accommodates the end of a first strap section or first strap, the drum being capable of engaging with a tensioning lever articulated on the drum, the latter being disengageable relative to the tensioning lever; a tension shaft to which a second strap section or second strap is secured; means for the temporary storage of the first strap comprising elements that are independent both of the shaft for tensioning the second section or second strap, and of the drum, the elements being mounted on the base.

### FIELD OF THE INVENTION

The invention relates to a strap or belt tensioning device, better known as a “ratchet”.

Said a device is conventionally used to tension straps, and more specifically on roof racks of motor vehicles, luggage racks, and generally speaking, when a strap has to be tensioned for the purpose of securing an item, a piece of luggage or any sort of product. The strap or straps in question may additionally be provided with a hook or any other functional member.

### PRIOR ART

“Ratchet” systems are in widespread use today for tensioning straps. In the main, they traditionally comprise a base secured to the end of a strap, said base comprising a shaft on which is mounted a rotating drum around which the other end of the strap, or even another strap, is intended to be wound. This drum is rotated by means of a lever, known as a tensioning lever, that rotates the drum in order to allow said other end of the strap to be wound thereon, and thereby tension said strap. More often than not, the drum is secured to toothed wheels intended to engage with retaining pawls mounted on the base, and additionally with drive pawls mounted on the tensioning lever, in order respectively to keep the strap tense and consequently drive the drum when the tensioning lever is activated.

Admittedly, devices of the type in question have demonstrated their effectiveness, and their straightforwardness of use. They do require however, as previously indicated, the provision of retaining pawls mounted on the base and drive pawls mounted on the tensioning lever, resulting in time-consuming machining operations and mounting operations.

Furthermore, in implementing such a device, it is sometimes deemed desirable to be able to store the strap in question. To this end, a proposal has been made, for example in document NL-1 017 968, for an additional storage shaft, operable via a crank, to be joined to the device. This shaft is placed in the vicinity of the strap tensioning lever, thereby significantly reducing the storage capacity. Additionally, the device as described necessarily results in the strap for storage being passed via the drum activated by the tensioning lever, making all storage independent of said strap impossible, and additionally, liable to affect the security of the strap tension.

In an alternative form, a proposal has been made in document DE-20 2004 000491, for the addition of an additional storage member, secured to said device, but this proves to take up a large amount of space, which is incompatible with the required use. Here too, the stored strap has to pass via the rotating drum operable by the tensioning lever, thereby affecting the required use of said independent storage means.

### DISCLOSURE OF TILE INVENTION

The intended aim of the invention is to provide a strap tensioning member that fulfils its prime function of properly tensioning the strap, but additionally, to be able to provide a storage means that is straightforward to use, takes up less space when not being acted upon, and is independent of the strap tensioning means themselves.

To this end, it relates to a strap tensioning device including:
a base defined by two parallel side walls, one of the ends of which receives a rotating drum, receiving the end of a first strap section or a first strap, capable of engaging with a tensioning lever articulated on the drum, the latter being disengageable relative to the tensioning lever;
a shaft extending between the two side walls defining the base, to which is secured a second strap section or a second strap;
means for the temporary storage of said strap.

According to the invention, said temporary strap storage means comprise elements independent both of the second section or second strap securing shaft, and of the drum engaging with the tensioning lever, said elements being mounted on the base.

In so doing, a strap tensioning device is obtained that fulfils its prime function, while being able to store a significant length of strap, and typically between 3 and 5 metres, independently operable relative to the tensioning means itself, with the result that the strap or straps in question are properly and securely tensioned, when the device in question is in operation.

According to a first embodiment of the invention, the base is relatively elongated, and the second section or second strap securing shaft, fixed to the side walls of the base, is not positioned in the vicinity of the end of the base opposite the one accommodating the rotating drum. The base further receives a temporary strap winding shaft, provided in the vicinity of the end of the base, opposite the one receiving the rotating drum. This shaft is to advantage provided with a slit capable of receiving one end of the strap for winding, and may be activated by a retractable crank.

In the context of this embodiment, the second section or second strap end securing shaft is provided with apertures in the side faces defining the base, said apertures extending along the main dimension of the side faces. To advantage, this securing shaft may assume at least one, and preferentially two, stable positions in said apertures:
one, in an operational pulling position, provided in the vicinity of the end of the base, opposite those accommodating the rotating drum;
the other, in an operational winding position provided substantially in the vicinity of the middle of said side faces.

This stability is obtained by means of one or more wire springs accommodated in apertures provided in the side faces, said springs being configured and shaped to engage with said second section or second strap securing shaft.

According to another embodiment of the invention, the device includes a cradle articulated on the second section or second strap securing shaft, then positioned in the vicinity of the end of the base opposite the one accommodating the rotating drum, said cradle being itself fitted with a shaft for accommodating the strap to be stored.

To advantage, according to this embodiment, this cradle is retractable in the volume defined by the base and the tensioning lever, the side faces defining the base being fitted with notches or cutouts for accommodating the strap winding shaft with which said cradle is provided.

According to a third embodiment of the invention, the winding shaft is positioned in the vicinity of the second section or second strap securing shaft, then positioned in the vicinity of the end of the base, opposite the one accommodating the rotating drum, and is itself accommodated in a housing fixed between the side faces defining the base and parallel to the second section or second strap securing shaft, the winding shaft being able to be retracted and pulled out of said housing in a direction parallel to said housing.

According to an alternative to the preceding embodiment, the winding shaft is coaxial with the second section or second strap securing shaft, the latter then functioning as said housing.

### BRIEF DESCRIPTION OF THE FIGURES

The manner in which the invention may be embodied, and the resulting advantages, will become clearer from the following embodiment examples, given for information purposes and non-restrictively, supported by the appended figures.

FIG. 1 is a diagrammatic perspective view of a first embodiment of the strap tensioning device of the invention, in the stowed position and free of any strap.

FIG. 2 is a diagrammatic perspective view of the device in FIG. 1, fitted with two strap sections.

FIG. 3 is a diagrammatic perspective view of this embodiment showing the storage of one of the strap sections.

FIG. 4 is an exploded diagrammatic view of the device shown in FIGS. 1 to 3.

FIG. 5 is a diagrammatic perspective view of an alternative to the device in FIGS. 1 to 4, with FIG. 6 showing the strap storage, and with FIGS. 7, 8 and 9 showing detailed views.

FIGS. 10 and 11 are diagrammatic perspective views of a second embodiment, in two different operational positions, FIGS. 12 and 13 showing for their part two different strap storage modes.

FIG. 14 is a diagrammatic view of a third embodiment of the invention; according to this third mode, FIG. 15 shows the strap storage, FIG. 16 a detailed view, and FIG. 17 an exploded view.

FIGS. 18 and 19 show an alternative to the previous embodiment, with FIG. 20 being a detailed view.

### DETAILED DESCRIPTION OF THE INVENTION

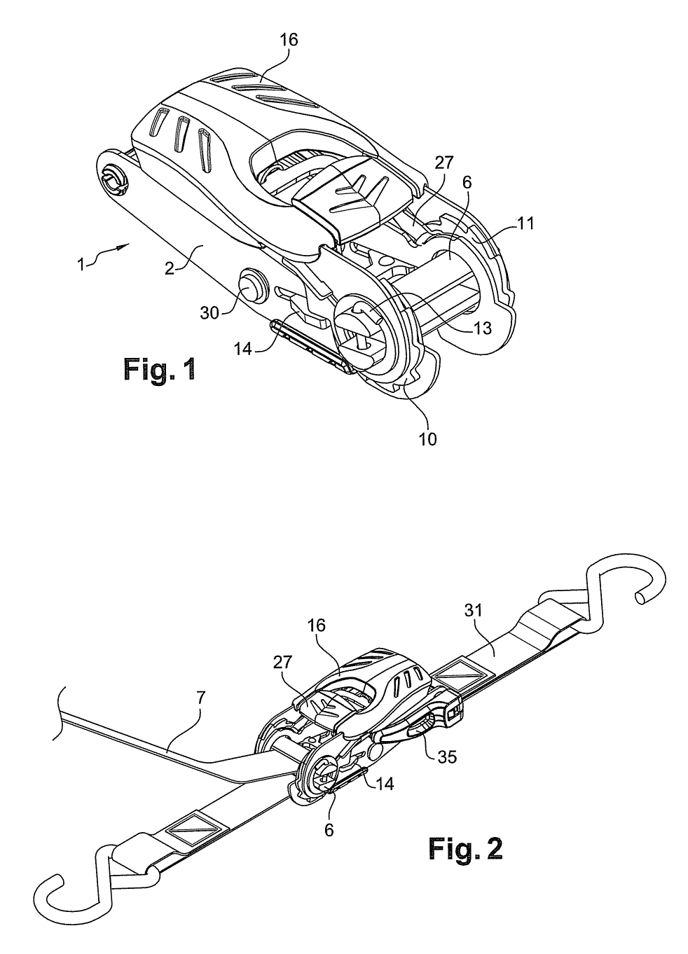

A first embodiment of the strap tensioning device of the invention is shown in FIG. 1.

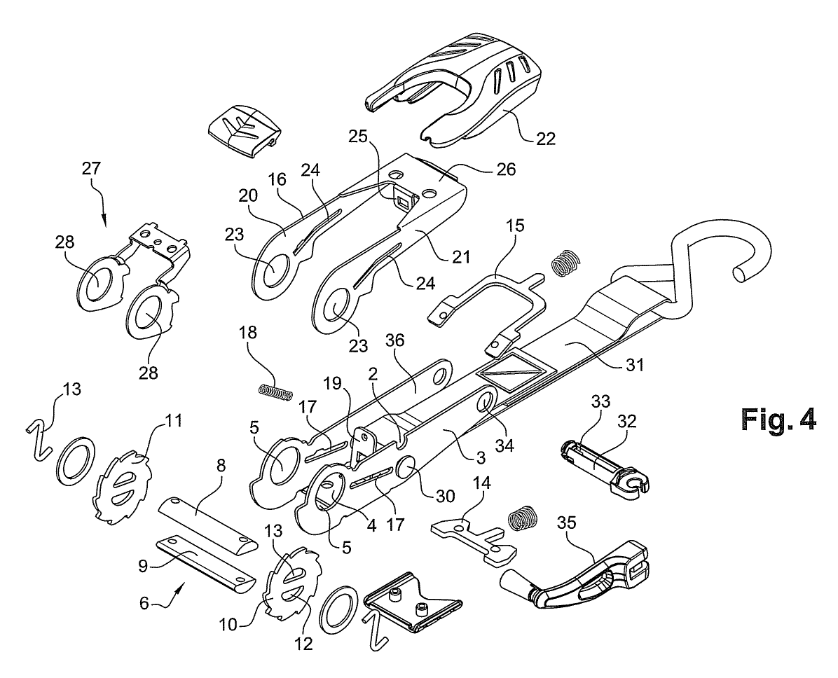

Basically, this comprises a base 1 defined by two side walls or faces 2 and 3, of metal for example, secured to each other by means of a lower plate 4 (FIG. 4).

One of the ends of the base so defined is intended to accommodate a rotating drum 6. To be more specific, the two side walls or faces 2, 3 are each provided at this level with a bore 5, which functions as a bearing capable of accommodating said rotating drum 6, on which the end of a strap 7 is intended to be wound, and consequently of tensioning said strap. In the case in point, this drum 6 comprises two half-shafts 8 and 9 of substantially circular transverse cross-section, and separated one from another by their respective engagement with two side toothed wheels 10 and 11, each pierced with two orifices 12 and 13 of corresponding shape. The two half-shafts 8 and 9 are secured in translatory motion by two folded shafts 13, possibly by caulking or snapping the ends of the half-shafts.

In the absence of any external constraint, the drum 6 is mounted loose in rotation in the bearings 5 and is then able to rotate in one direction or in the other.

As will have been understood, given the embodiment of the drum 6, the latter is secured to the side toothed wheels 10 and 11.

The teeth with which said toothed wheels 10, 11 are provided are shaped so as to promote the rotation of the drum in one direction, and on the contrary to block its rotation in the other direction. In fact, they engage with, on the one hand, a retaining pawl 14, provided in the base 1, and on the other hand, a drive pawl 15, provided in a tensioning lever 16.

The retaining pawl 14 comprises a rigid blade, of metal for example, whereof two side excrescences are able to slide into a through aperture 17 provided in the side walls or faces 2 and 3 respectively of the base 1. The motion of this pawl is purely translatory. It is permanently subject to the action of a resilient return member, typically comprising a spring 18 that presses against an excrescence 19 issuing from the lower plate 4 connecting the side faces 2 and 3 of the base 1, and causing the pawl 14 to thrust against the teeth of the toothed wheels 10 and 11.

The tensioning lever 16 is articulated on the drum 6. It comprises a rigid structure comprising two parallel side faces 20, 21, secured to each other by a rear plate 26, and able to accommodate a gripping area 22 by being snapped on. The end of the side faces 20, 21 opposite the gripping area, defines two flanges also parallel, each provided with a bore 23, the internal diameter of which substantially corresponds to the external diameter of the drum 6. The latter therefore constitutes the shaft for articulating the tensioning lever 16.

The drive pawl 15 fitted to the tensioning lever 16 also comprises a metal, and therefore rigid, blade, provided with two side excrescences each able to move in a through aperture 24 provided in the side faces 20, 21 of said lever. As with the retaining pawl 14, the drive pawl 15 is subject to the action of a resilient return member and for example a spring (not shown), that presses on a projection 25 issuing from the rear plate 26 that secures the side faces 20 and 21 of the tensioning lever, in order to cause said drive pawl to thrust permanently against the teeth of the toothed wheels 10 and 11.

In so doing, the two retaining and drive pawls respectively are permanently engaged or, put another way, enmesh with the teeth of the toothed wheels 10 and 11 by virtue of the respective actions of the springs to which they are subjected. In so doing, and given the particular orientation of said teeth, said pawls block the rotation of the drum 6 in a particular direction, and in the case in point in a clockwise direction.

Conversely, still by virtue of the particular orientation and shape of said teeth, this engagement of the retaining and drive pawls with the teeth, does not block the rotation of said drum 6 in the opposite direction. And so, when a user wishes to tension the strap 7, he activates the tensioning lever 16 by moving it away from the base 1, causing the toothed wheels to rotate by means of the drive pawl 15, and causing the drum 6 to rotate. Pulling the lever 16 down towards the base 1 is not detrimental to the tension previously obtained because the retaining pawl 14 engages with the toothed wheels 10 and 11, thereby holding the drum in the position it was in when the tensioning lever 16 was activated previously.

The device also includes an unlocking lever 27, also articulated on the drum 6. In the example described, this unlocking lever 27 is operable independently of the drive or tensioning lever 16. It is also provided with two bores 28, the internal diameter of which substantially corresponds to the external diameter of the drum 6. The faces defining the bores 28 have a gradually widening cam-shaped section, intended to engage with the retaining pawl 14 and the drive pawl 15, in such a way as to release the drum 6 from the constraints exerted by these two members.

And so, in order to release the drum 6, the unlocking lever 27 has merely to be rocked by simple rotation relative to its axis of articulation.

The base 1 further comprises a shaft 30 situated in the embodiment described substantially in the middle of the side walls 2 and 3 defining said base. This shaft 30, parallel to the drum 6, is intended to accommodate the end of another section 31 or a second strap. This second section is secured to this shaft 30, by a seam for example.

Additionally, the end of the base 1 opposite the one accommodating the drum 6 accommodates a winding or storage shaft 32, provided with a slit 33 intended to accommodate the end, particularly of the strap 7, when the latter is not being employed to provide tension. This shaft 32 is accommodated in bores 34 provided in the side faces 2 and 3 of the base 1, bores functioning as bearings in which the shaft 32 is able to rotate freely. To this end, one of the ends of the shaft 32 is able to engage with a crank 35, whereof the free end of the arm is able to be retracted inside the device, the side face 3 of the base 1 being provided to this end with a cutout 36.

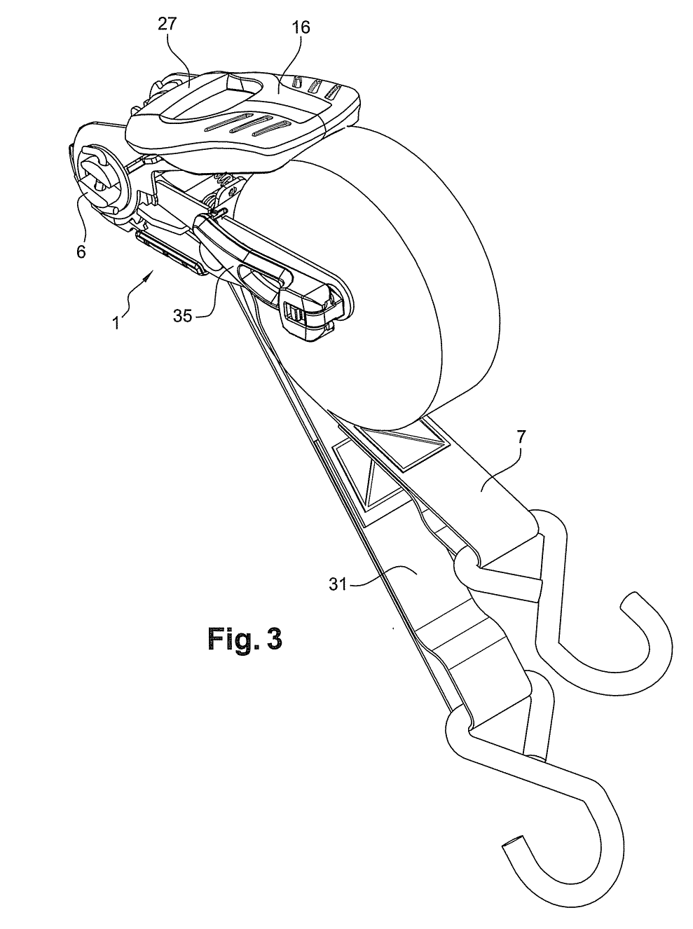

The temporarily stored strap 7 can thus be seen in FIG. 3 and, because of the relative gap between the shaft 30 and the shaft 32, it becomes possible to store a relatively large length of strap, typically close to 5 metres, and to do so straightforwardly, without causing too much space to be taken up.

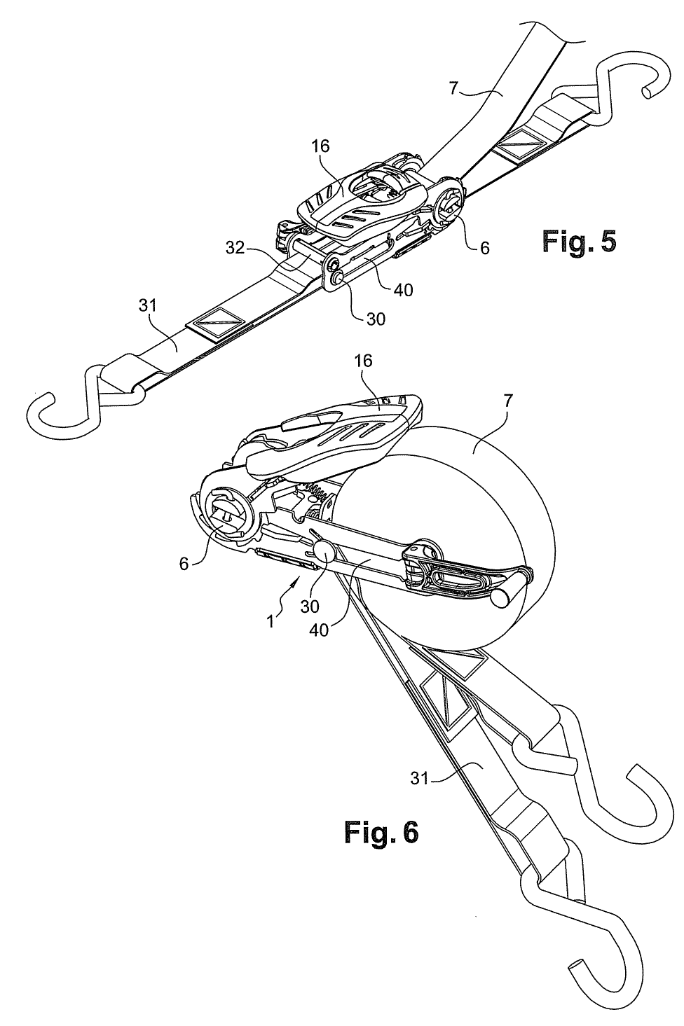

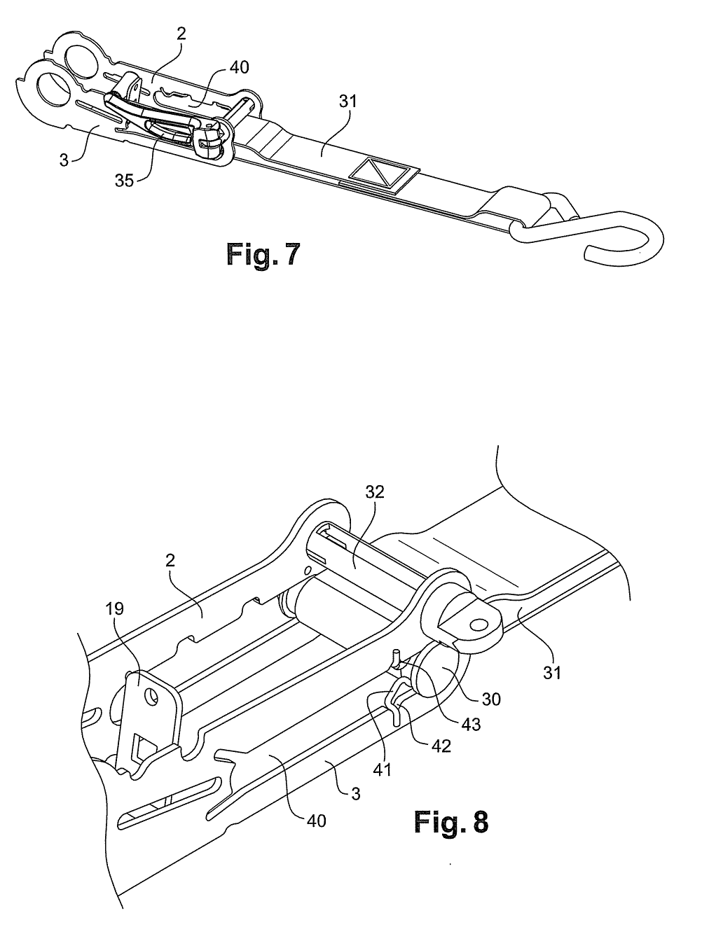

According to one alternative to the previous embodiment shown in FIGS. 5 to 9, the shaft 30 which was in a fixed position in FIGS. 1 to 4, is able to move within an aperture 40 provided in the side faces 2 and 3 defining the base 1. These apertures extend substantially in the same direction as the main dimension of said side faces 2, 3.

In this embodiment, the winding or temporary storage shaft 32 is positioned slightly higher relative to the previous embodiment in said side faces.

In the tension position, the shaft 30 is stopped against the end of the apertures 40 close to the end of the base opposite the one accommodating the drum 6, as shown in FIGS. 5, 8 and 9. In this configuration, the temporary storage shaft 32 does not fulfil any function and does not hinder the operation of the cable tensioning device. Additionally, and as shown in FIG. 8, the shaft 30 may be held in a stable manner in this position by means of a wire spring 41 housed in cutouts 42, 43 provided in said side faces 2 and 3.

Conversely, when the device is no longer in tension and it is wished to temporarily store the strap 7, said shaft 30 is moved along the apertures 40 towards the drum 6, so as to release the volume needed to wind the strap properly, as shown in FIG. 6.

In a developed version as shown in FIGS. 7 and 9, the tension shaft 30 may be stored in a stable position at the bottom of the apertures 40 close to the drum 6, also by means of a wire spring 45, here too, accommodated in cutouts provided in the side faces 2 and 3. In this embodiment, two stable positions are therefore defined for positioning the tension shaft 30, an operational tension position, and a stowed position respectively, so that the volume needed to wind the strap 7 on the shaft 32 can be disengaged.

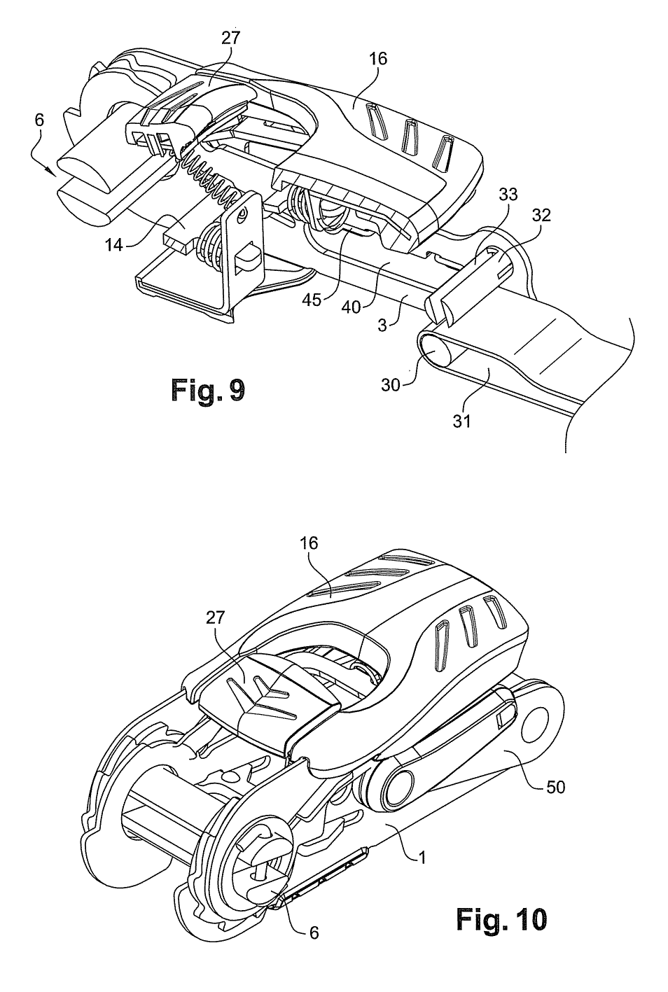

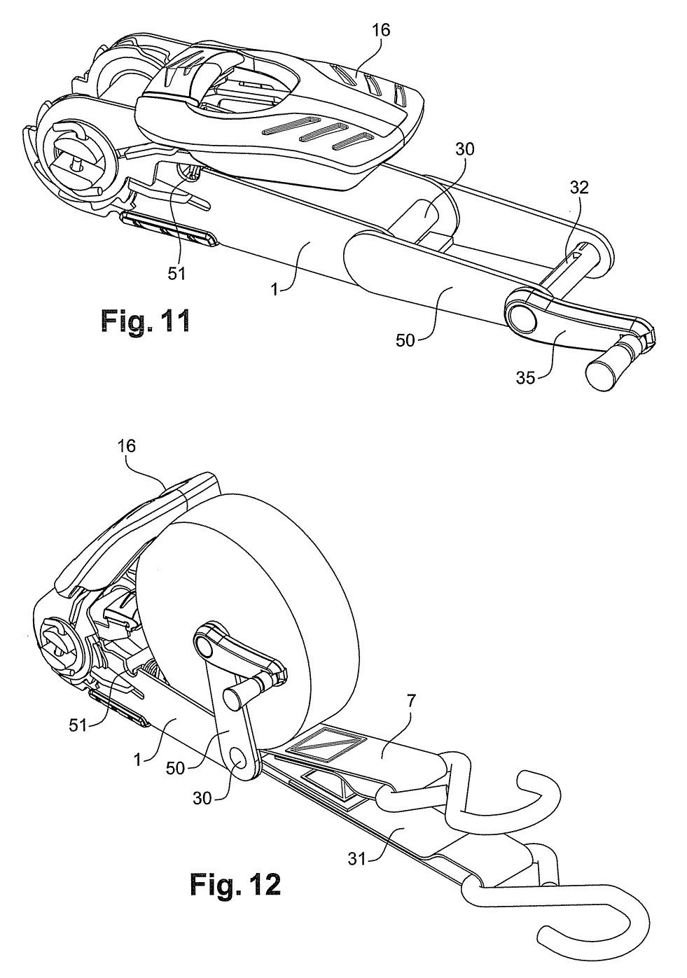

According to a second embodiment of the invention shown in FIGS. 10 to 13, the shaft 30 acts as articulation shaft for a cradle 50, able to be retracted simply by rotating inside the base 1, the side faces 2 and 3 being fitted with cutouts 51 capable of accommodating the winding shaft 32 mounted at the end of the cradle.

In FIGS. 12 and 13 can be seen two modes of storing the strap 7, whereof the sizeable volume appropriate for this storage can still be seen.

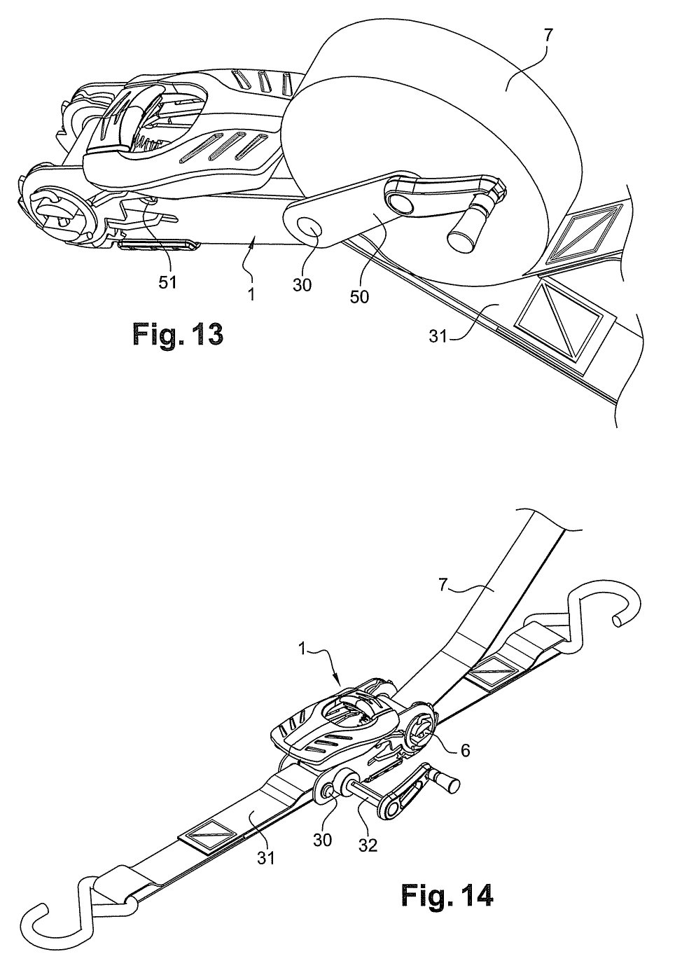

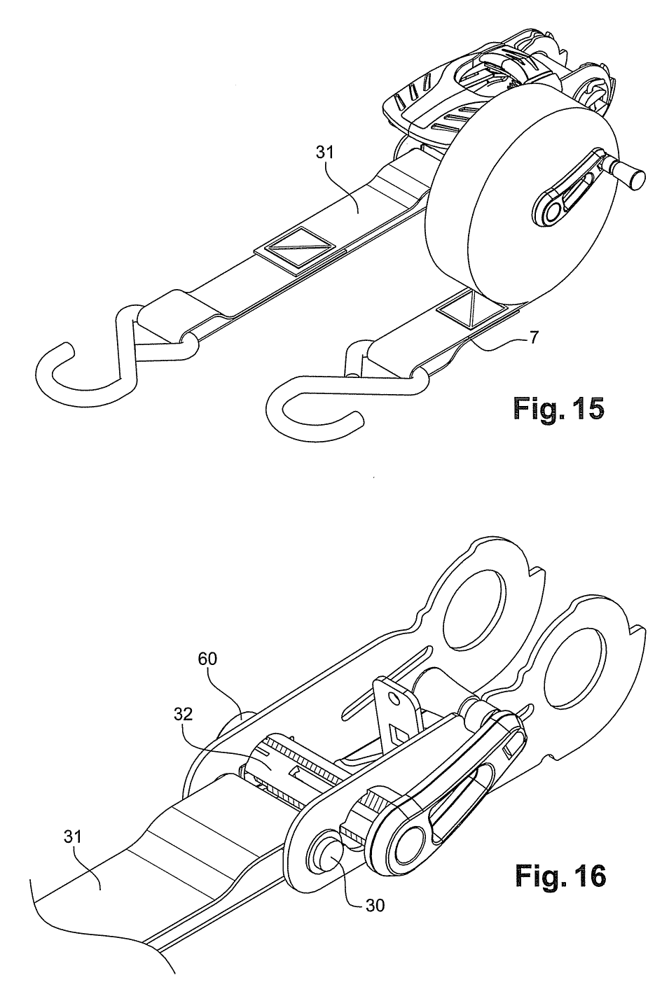

According to a third embodiment of the invention, as shown in FIGS. 14 to 17, the tension shaft 30 is fixed, as standard, to the opposite end of the base to the one that accommodates the drum 6. Immediately adjacent, the temporary storage shaft 32 is accommodated in a cylindrical housing 60, the side faces 2 and 3 of the base 1 being provided to this end with corresponding through apertures 61.

The winding shaft 32 itself is able to be retracted away from this housing 60 merely by pulling, said shaft being thereby offset from the base, as can be seen in FIG. 14, to allow the strap 7 to be wound, as can be seen in FIG. 15. It will be understood that because of this offset, it is possible to wind an even larger length of strap than previous embodiments. The housing 60 or the shaft 32 is fitted to advantage with a hard point, capable of engaging with the shaft or housing, allowing two positions of said shaft 32 to be defined, an operational winding position, away from the housing 60 (FIG. 14) and a position retracted inside the housing (FIG. 16) respectively.

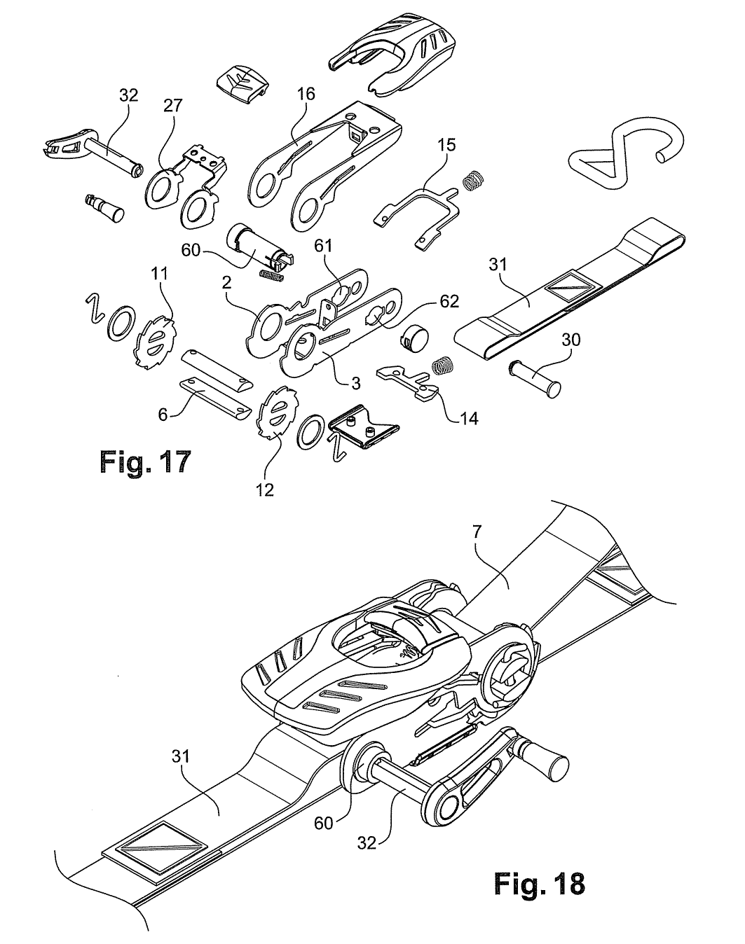

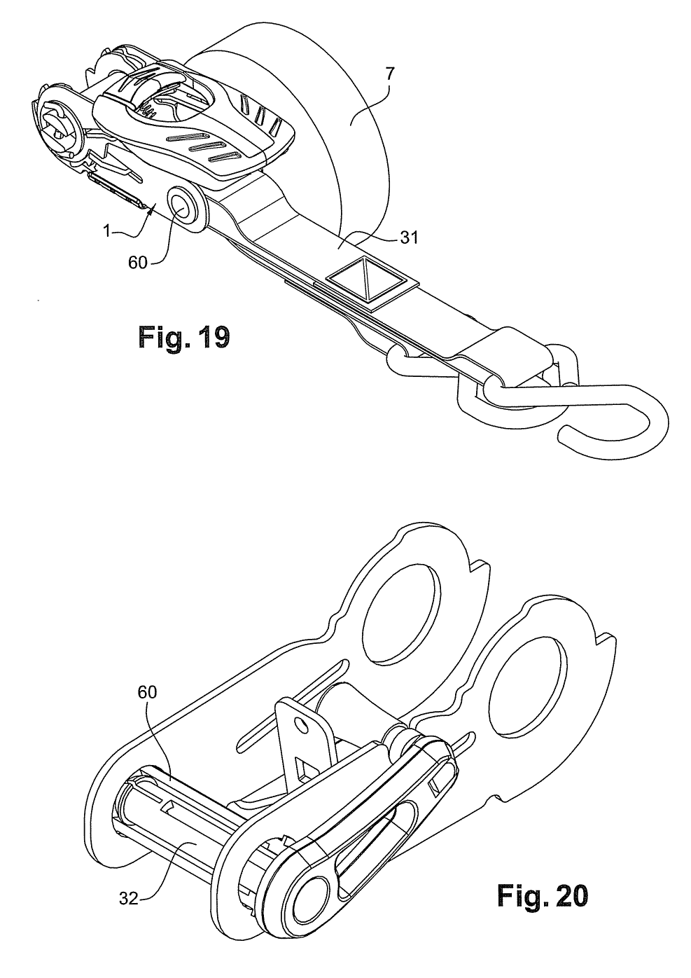

According to an embodiment alternative shown in FIGS. 18 to 20, the housing 60 functions as a shaft for accommodating or tensioning the second strap section 31, in other words it fulfils the function of the shaft 30. The temporary storage shaft 32, slides, as in the previous case, inside this housing 60, as can be seen in FIG. 18, which simplifies the device and here too provides a sizeable strap storage.

The full advantage of the various embodiments of the invention can therefore be seen, both in terms of strap storage length, when the strap is not in tension, and in terms of reducing the space requirement generated by said storage, and lastly, in terms of securing the tension.

1. A strap tensioning device including:
a base defined by two parallel side walls or faces, one of the ends of which accommodates a rotating drum accommodating the end of a first strap section or a first strap, said drum being capable of engaging with a tensioning lever articulated on the drum, said drum being disengageable relative to the tensioning lever;
a tension shaft extending between the two side walls defining the base, to which a second strap section or a second strap is secured;
means for the temporary storage of said first strap comprising elements that are independent both of the shaft for tensioning the second section or second strap and of the drum, said elements being mounted on the base.

2. The strap tensioning device as claimed in claim 1, wherein the shaft for tensioning and securing the second section or second strap is not positioned in the vicinity of the end of the base opposite the one accommodating the rotating drum, and wherein the base further accommodates a shaft for the temporary winding of the first strap, provided in the vicinity of the end of the base, opposite the one accommodating the rotating drum.

3. The strap tensioning device as claimed in claim 2, wherein the side faces of the base are provided with apertures, extending along the main dimension of said side faces, in which the shaft for tensioning and securing the end of the second section or second strap is accommodated.

4. The strap tensioning device as claimed in claim 3, wherein the apertures further comprise one or more wire springs intended to engage with the tension shaft so as to define at least one, and preferentially two stable positions of said shaft in the apertures:
an operational pulling position, capable of holding said shaft in the vicinity of the end of the base, opposite those accommodating the rotating drum; and
an operational winding position, capable of holding said shaft substantially in the vicinity of the middle of said side faces.

5. The strap tensioning device as claimed in claim 1, wherein it includes a cradle articulated on the tension shaft for tensioning and securing the second section or second strap, said cradle being positioned in the vicinity of the end of the base opposite the one accommodating the rotating drum, said cradle itself being provided with a shaft for winding the first strap.

6. The strap tensioning device as claimed in claim 5, wherein the cradle is retractable in a volume defined by the base and the tensioning lever, the side faces defining the base being provided with notches or cutouts for accommodating the shaft for winding the first strap.

7. The strap tensioning device as claimed in claim 1, wherein the shaft for winding the first strap is positioned in the vicinity of the shaft for tensioning and securing the second section or second strap, and in the vicinity of the end of the base opposite the one accommodating the rotating drum, said winding shaft being itself accommodated in a housing fixed between the side faces defining the base and orientated parallel to the shaft for tensioning and securing the second section or second strap, the winding shaft being able to be retracted and pulled out of this housing in a direction parallel to said housing, in order to allow the first strap to be properly wound.

8. The strap tensioning device as claimed in claim 7, wherein the winding shaft is coaxial with the shaft for tensioning and securing the second section or second strap, the latter then fulfilling the function of the housing.

9. The strap tensioning device as claimed in claim 2, wherein the shaft for winding the first strap is fitted with a slit capable of accommodating one end of the strap to be wound, said shaft being able to be activated by a retractable crank.
